(19) United States
(12) Patent Application Publication
(10) Pub. No.: US 2014/0220215 A1
(43) Pub. Date: Aug. 7, 2014

(54) OXIDATIVELY-STABILIZED FATS CONTAINING VERY LONG-CHAIN OMEGA-3 POLYUNSATURATED FATTY ACIDS

(71) Applicants: Diliara Iassonova, Fort Collins, CO (US); Linsen Liu, Irvine, CA (US)

(72) Inventors: Diliara Iassonova, Fort Collins, CO (US); Linsen Liu, Irvine, CA (US)

(73) Assignee: Cargill, Incorporated, Wayzata, MN (US)

(21) Appl. No.: 14/122,472

(22) PCT Filed: May 31, 2012
(86) PCT No.: PCT/US12/40233

§ 371 Date: Apr. 17, 2014

Related U.S. Application Data
(60) Provisional application No. 61/491,825, filed on May 31, 2011.

(51) Int. Cl. A23D 7/00

(52) U.S. Cl. CPC A23D 7/003
USPC 426/541; 426/607

(57) ABSTRACT

The present disclosure provides edible, non-hydrogenated fats with good oxidative stability despite elevated levels of very long chain omega-3 polyunsaturated fatty acids, e.g., EPA and DHA from a fish oil, and algal oil, or a vegetable oil.

### TECHNICAL FIELD

The present disclosure relates generally to edible fats and food products made with edible fats. More particularly, the present disclosure describes edible fats that are oxidatively stable even though they have elevated levels of fish oils or other oils containing very long chain omega-3 polyunsaturated fatty acid. Food products made with such fats exhibit surprisingly long shelf life.

### BACKGROUND

Consumers are paying increasing attention to not only the total fat content in food products, but also the nature of those fats. In general, foods low in saturated fats and trans-fats are viewed as healthier. Consumers also perceive some health benefits in increasing the levels of omega-3 fatty acids in one's diet; fish oil in particular is gaining increased attention.

Omega-3 fatty acids, also referred to as n-3 fatty acids, are unsaturated fatty acids having a carbon-carbon double bond in the third position. From a nutritional standpoint, the most important omega-3 fatty acids are probably α-linolenic acid (“ALA”), eicosapentaenoic acid (“EPA”), and docosahexaenoic acid (“DHA”). ALA is an 18-carbon fatty acid moiety having three carbon-carbon double bonds (commonly referred to as C18:3 in shorthand notation), one of which is at the n-3 position. EPA is a 20-carbon fatty acid moiety having 5 carbon-carbon double bonds (“C20:5”) and DHA is a 22-carbon fatty acid moiety having 6 carbon-carbon double bonds (“C22:6”).

Generally, the oxidative stability of a fatty acid decreases noticeably as the number of carbon-carbon double bonds, or the degree of unsaturation, increases. Unfortunately, ALA, EPA, and DHA are all polyunsaturated fats that tend to oxidize fairly readily. EPA (with 5 carbon-carbon double bonds) is significantly more prone to oxidation than ALA; DHA (with 6 carbon-carbon double bonds) is even more prone to oxidation than EPA. As a consequence, increasing the omega-3 content tends to reduce the shelf life of many food products. These problems become particularly acute with fish oil, which has a significant amount of EPA and DHA.

### DETAILED DESCRIPTION

### Overview

Specific details of several embodiments of the disclosure are described below. One aspect of the present disclosure is directed toward an edible, non-hydrogenated fat having at least 1 wt % omega-3 fatty acids with a carbon chain length of twenty or greater and three or more carbon-carbon double bonds, no more than 10 wt % saturated fatty acids, and an Oxidative Stability Index (“OSI”) at 110° C. of at least 10 hours in the absence of added antioxidants.

Another aspect of the disclosure provides an edible, non-hydrogenated fat having at least 1 wt % omega-3 fatty acids with a carbon chain length of twenty or greater and three or more carbon-carbon double bonds, and an Oxidative Stability Index (“OSI”) at 110° C. of at least 37 hours. This fat includes a) a first fat including a rapeseed oil having at least about 65 wt % oleic acid; b) a second fat having at least 10 wt % of omega-3 fatty acids with a carbon chain length of twenty or greater and three or more carbon-carbon double bonds; and c) an antioxidant.

In one other aspect, this disclosure provides an edible fat having a combination of a) rapeseed oil having at least about 65 wt % oleic acid, b) fish oil, and c) an antioxidant. This edible fat a) has an Oxidative Stability Index (“OSI”) at 110° C. of at least 37 hours; b) contains at least 1 weight percent (“wt %”) omega-3 fatty acids with a carbon chain length of twenty or greater and three or more carbon-carbon double bonds; and c) contains no more than 10 wt % saturated fatty acids.

Still another aspect of the disclosure provides an edible baked food product formed by baking a composition at a temperature of at least 350° F. for at least 15 minutes. The composition includes an edible, non-hydrogenated fat comprising a) a rapeseed oil having at least 65 weight percent (“wt %”) oleic acid, b) a marine-, algal-, or vegetable-sourced oil containing omega-3 fatty acids with a carbon chain length of twenty or greater and three or more carbon-carbon double bonds, and c) an antioxidant. As used herein, the terms “vegetable oil” and “vegetable-sourced oil” include oil from oilseeds such as rapeseed or soybeans. The edible, non-hydrogenated fat has an Oxidative Stability Index (“OSI”) at 110° C. of at least 37 hours and at least 1 wt % omega-3 fatty acids with a carbon chain length of twenty or greater and three or more carbon-carbon double bonds.

A method of making an edible baked food product in accordance with a further aspect of the disclosure includes mixing a composition comprising a first food ingredient, which may be flour, and an edible, non-hydrogenated fat and baking the composition at a temperature of at least 350° F. for at least 15 minutes. The edible, non-hydrogenated fat includes a) a rapeseed oil having at least 65 weight percent (“wt %”) oleic acid, b) a marine-, algal-, or vegetable-sourced oil containing omega-3 fatty acids with a carbon chain length of twenty or greater and three or more carbon-carbon double bonds, and c) an antioxidant. The edible, non-hydrogenated fat has an Oxidative Stability Index (“OSI”) at 110° C. of at least 37 hours and at least 1 wt % omega-3 fatty acids with a carbon chain length of twenty or greater and three or more carbon-carbon double bonds.

Unless otherwise indicated, all numbers expressing quantities of ingredients, properties such as molecular weight, percentages, reaction conditions, and so forth used in the specification and claims are to be understood as being modified by the term “about.” Accordingly, unless indicated to the contrary, the numerical parameters set forth are approximations that may depend upon the desired properties sought.

### Edible Fats—Components

Embodiments of the disclosed edible fats include a first fat, which in some embodiments has at least 63 wt % oleic acid; a second fat that includes very long chain omega-3 polyunsaturated fatty acid (i.e., omega-3 polyunsaturated fatty acid having a carbon chain length of twenty or greater); and, preferably, an antioxidant. Suitable components are described below.

### A. High Oleic Acid First Fat

The first fat is an edible fat and may be relatively high in oleic acid, typically including at least 63 wt % oleic acid, a monounsaturated 18-carbon acid moiety commonly referred to as C18:1. In select embodiments, the first fat includes at least 65 wt %, e.g., 67 wt % or more, oleic acid, with select implementations including at least 70 wt %, e.g., 73 wt % or more, 75 wt % or more, 80 wt % or more, 82 wt % or more, or 84 wt % or more, oleic acid.

In the compositions described herein, the stated fatty acid percentages are based on the total weight of fatty acids in the fat and may be determined using AOCS Official Method Ce 1c-89. In the Examples set forth below, unless otherwise indicated, the fats are analyzed via a gas chromatograph determination of fatty acid profile per the American Oil Chemist's Society Official Method Ce 1c-89, modified as spelled out below in connection with the Examples.

The first fat may also be relatively low in saturated fatty acids, in some embodiments comprising no more than 12 wt % saturated fatty acids. For example, the first fat may contain 10 wt % or less, e.g., 9 wt % or less, 7 wt % or less, no more than 5 wt %, or no more than 4.5 wt %, or no more than 4 wt %, saturated fatty acids. Use of a first fat with lower saturated fatty acid content can reduce the total amount of saturated fat in the edible fat composition, particularly if the edible fat composition includes more of the first fat than the second fat. Although the first fat may be partially hydrogenated, a non-hydrogenated oil is preferred for many applications as it will limit the content of both saturated fat and trans-fats. As noted above, lower total saturated fat and trans-fat contents have positive health connotations in consumers' minds. For other food applications that require a structured fat, it may be advantageous to include a hydrogenated or partially hydrogenated oil.

If so desired, the first fat may be relatively low in ALA. In some embodiments, the first fat comprises no more than 5.0 wt % ALA, e.g., no more than 4.0 wt % or no more than 3.5 wt % ALA, with some useful embodiments employing a first fat having no more than 3.0 wt % ALA, no more than 2 wt % ALA, no more than 2.5 wt % ALA, or no more than 1 wt % ALA. In other embodiments, however, the first fat may have higher levels of ALA to further increase the total omega-3 fatty acid content of the edible fat composition.

In some implementations, the first fat desirably has no more than 20 wt %, preferably no more than 18 wt %, e.g., 15 wt % or less, linoleic acid, which is an 18-carbon acid moiety with two carbon-carbon double bonds commonly referred to as C18:2. In some embodiments, the first fat includes no more than 12 wt % linoleic acid, no more than 10 wt % linoleic acid, or no more than 9 wt % linoleic acid.

The first fat may be free, or at least substantially free (e.g., no more than 0.1 wt %), of omega-3 polyunsaturated fatty acids having more than 18 carbon atoms and more than two carbon-carbon double bonds. It is anticipated that the first fat will be free of both EPA and DHA.

Although the first fat may come from a variety of fat sources, e.g., algal oils, in one embodiment the first fat is, or at least includes, a vegetable oil. Typically this oil will be commercially refined, bleached, and deodorized, though a less-processed oil, such as an expelled oil or a cold-pressed oil, may be used. In a preferred embodiment, the first fat is rapeseed oil, which encompasses what is commonly called “canola” oil in North America. Suitable rapeseed oils meeting the above-specified criteria are commercially available from Cargill, Incorporated of Wayzata, Minn., USA under the CLEAR VALLEY® trademark, such as CLEAR VALLEY 65-brand (“CV65”), CLEAR VALLEY 75-brand (“CV75”), or CLEAR VALLEY 80-brand (“CV80”) canola oils. High-oleic sunflower oil (e.g., CLEAR VALLEY brand) having at least about 65 wt % oleic acid and high-oleic, low-linolenic soybean oil may also suffice for some specific applications.

### B. VLC Omega-3 PUFA-Containing Second Fat

Edible fats disclosed herein may employ a second fat, which preferably is both edible and non-hydrogenated, that serves as a source for very long chain omega-3 polyunsaturated fatty acid content. As used herein, “very long chain omega-3 polyunsaturated fatty acid” and “VLC omega-3 PUFA” refer to a long chain polyunsaturated omega-3 fatty acid with a carbon chain length of 20 or greater and 3 or more carbon-carbon double bonds. Such fatty acids include, but are not limited to, EPA, DHA, and DPA; “DPA” refers to the omega-3 isomer of docosapentaenoic acid (also known as clupanodonic acid), which is a 22-carbon fatty acid moiety having 5 carbon-carbon double bonds (C22:5n-3). The term “VLC omega-3 PUFA” encompasses both a single type of fatty acid (e.g., EPA or DHA) and multiple types of fatty acids (e.g., EPA and DHA) where used below unless context requires otherwise.

The second fat can have at least 5 wt % VLC omega-3 PUFA, at least 8 wt %, or desirably at least 10 wt % VLC omega-3 PUFA. In some preferred embodiments, the second fat includes at least 13 wt %, at least 15 wt %, at least 16 wt %, at least 25 wt %, at least 30 wt %, or at least 36 wt %, e.g., 20-45 wt %, VLC omega-3 PUFA. Edible fats known to have such high VLC omega-3 PUFA contents include those derived from specific animals, especially marine animals, specific algae, and fermentation. In some embodiments, the edible fat including VLC omega-3 PUFAs may be derived from a vegetable source, such as, for example, rapeseed that has been modified to produce VLC omega-3 PUFAs. One particularly useful source for the second fat is fish oil, which commonly is derived from a variety of fish species, e.g., sardines, anchovies, and salmon, and is widely available on a commercial basis, e.g., from Jedwards International, Inc. of Quincy, Mass., USA. Krill is another marine animal that is a viable source for VLC omega-3 PUFA; krill oil is commercially available from Azantis Inc. of Boulder, Colo. Martek Biosciences (Columbia, Md., USA) sells algal oils that have as much as 45% DHA under the names DHASCO and LIFE'SDHA. One process for producing EPA and DHA via fermentation is set forth in U.S. Pat. No. 6,451,567 (Barclay). Methods of preparing rapeseed that has been modified to produce VLC omega-3 PUFAs are known to those of skill in the relevant arts and are described, for example, in U.S. Pat. No. 7,544,859 (Heinz et al.), U.S. patent application Ser. No. 10/566,944 (Zank et al.), U.S. Pat. No. 7,777,098 (Cirpus et al.), U.S. patent application Ser. No. 12/768,227 (Cirpus et al.), U.S. patent application Ser. No. 10/590,457 (Cirpus et al.), U.S. Pat. No. 8,049,064 (Cirpus et al.), Ser. No. 12/438,373 (Bauer et al.), and International Patent Application No. PCT/CA2007/001218 (Meesaptodsuk et al.), the entireties of which are incorporated herein by reference.

Fish oils and other oils containing VLC omega-3 PUFA are notoriously oxidatively unstable. For that reason, most fish oils are sold in encapsulated form, e.g., as MEG-3 Powder from Ocean Nutrition Canada Limited of Dartmouth, Nova Scotia, Canada. As noted below, however, aspects of this disclosure provide edible fats that have excellent oxidative stability without the complexity and expense of encapsulation. Accordingly, it is preferred that the second fat be in bulk form instead of encapsulated.

The second fat may contain one specific type of VLC omega-3 PUFA, e.g., DHA or EPA. Algal oils available from Martek Biosciences, for example, contain DHA, but no EPA. In one useful embodiment, however, the second fat includes both EPA and DHA. Fish oil, krill oil, and oil from fermentation, as described in U.S. Pat. No. 6,451,567, contain both EPA and DHA and are thus preferred for certain embodiments of the disclosure. In some embodiments, the second fat including both EPA and DHA may be derived from a vegetable-sourced oil, such as, for example, a rapeseed oil. In some embodiments, the rapeseed oil is a canola oil that includes at least 2 wt %, at least 3 wt %, at least 5 wt %, at least 7 wt %, at least 10 wt %, at least 13 wt %, at least 15 wt %, or at least 20 wt % VLC Omega-3 PUFAs. In some embodiments, such canola oil includes at least 2 wt %, at least 3 wt %, at least 5 wt %, at least 7 wt %, at least 10 wt %, at least 13 wt %, at least 15 wt %, or at least 20 wt % combined DHA and EPA.

The conventional commercial processes of refining, bleaching, and deodorizing can be deleterious to fats that contain VLC omega-3 PUFA, promoting oxidation of the polyunsaturated fat. Accordingly, it may be advantageous to employ a second fat that is an expelled oil, a cold-pressed oil, or a solvent-extracted oil that has not been subjected to the full commercial refining, bleaching, and deodorizing process.

### C. Antioxidant

Edible fats of this disclosure optionally include at least one antioxidant. Any of a wide range of antioxidants recognized for use in fats and other foods are expected to work well, including but not limited to tertiary-butylhydroquinone (“TBHQ”), butylhydroxyanisole (“BHA”), butylhydroxytoluene (“BHT”), propyl gallate (“PG”), vitamin E and other tocopherols, rosemary oil, rosemary extract, green tea extract, ascorbic acid, ascorbyl palmitate, or selected polyamines (see, e.g., U.S. Pat. No. 6,428,461 and Shahidi, Fereidoon, ed. Bailey's Industrial Oil and Fat Products. Sixth ed. Vol. 1. John Wiley & Sons, 2005, the entireties of which are incorporated herein by reference). Such antioxidants may be used alone or in combination. One rosemary oil-based antioxidant is commercially available from Kalsec, Inc. of Kalamazoo, Mich., USA under the trade name DURALOX. In one implementation that has been found to work well, the antioxidant comprises TBHQ. Rosemary extracts and green tea extracts that may be used in embodiments of the present disclosure are available under the trade name GUARDIAN and are available from Danisco, Copenhagen, Denmark.

As used herein, the term “maximum antioxidant content” (“Max. AO”) refers to the maximum amount (weight percent) of an antioxidant allowed in a food product by the FDA in 21 CFR as of 1 Sep. 2009 that preferably has no material adverse sensory impact on the food product to which it is added. In some embodiments, the Max. AO of BHA, TBHQ, BHT, or PG in the edible fat may be 200 ppm; lesser levels, e.g., 150 ppm, or 100 ppm, are also expected to work well. In some embodiments, the Max. AO of rosemary extracts or green tea extracts in the edible fat may be less than 5,000 ppm; lesser levels, e.g., less than 4,000 ppm, less than 3,000 ppm, less than 2,000 ppm, or less than 1,000 ppm, are also expected to work well.

### Edible Fats—Properties

### A. Generally

Edible fats in accordance with aspects of this disclosure may include at least 1 wt %, preferably at least 1.5 wt %, VLC omega-3 PUFA. Desirably, the edible fats have a VLC omega-3 PUFA content of at least 2 wt %, e.g., at least 2.5 wt %, and preferably at least 3 wt % or at least 3.5 wt %. Some preferred embodiments may have 0.55-7 wt %, e.g., 1-5 wt %, 1-4 wt %, or 1.5-3.5 wt %, VLC omega-3 PUFA.

The amount of VLC omega-3 PUFA in the edible fat will depend in part on the nature and relative percentages of the first and second fats, with VLC omega-3 PUFA content increasing as the amount of the second fat is increased. The precise combination of first and second fats and the resultant VLC omega-3 PUFA content useful in any given application will depend on a variety of factors, including desired shelf life, flavor profile, and the type of food application for which the edible fat is intended. With the present disclosure in hand, though, those skilled in the art should be able to select suitable combinations of the identified first and second fats for a particular application.

As explained previously, saturated fats and trans-fats have negative health connotations. Certain edible fats of the disclosure, therefore, may have relatively low levels of such fats. For example, some useful implementations have less than 12 wt % saturated fat, preferably no more than 10 wt %, e.g., no more than 9 wt % or no more than 8 wt %, saturated fat. In certain applications, the edible fat may have less than 7 wt %, desirably less than 5 wt %, saturated fat. Although most commercially-refined, bleached, and deodorized vegetable oils will contain some minor level of trans-fat, the edible fat desirably includes no more than 3.5 wt % trans-fat, preferably no more than 3 wt %, e.g., 0-2 wt %, trans-fat.

In some implementations, the edible fat may be a structured fat that is solid or semi-solid at room temperature. In other applications, however, the edible fat is pourable at room temperature. For example, the oil may have a solid fat content (determined in accordance with AOCS Cd 16b-93) of no more than 20%, e.g., no more than 12% or no more than 10%, at 10° C.

### B. Oxidative Stability

Oxidative stability depends on many factors and cannot be determined by fatty acid profile alone. It is generally understood, though, that VLC omega-3 PUFA tend to oxidize more readily than oleic acid and other more saturated fatty acids. On a relative oxidative stability scale, linoleic acid is significantly more stable than VLC omega-3 PUFA, oleic acid is significantly more stable than linoleic acid, and saturated fatty acids are even more stable than oleic acid.

Edible fats of this disclosure exhibit notably high oxidative stability despite their relatively high VLC omega-3 PUFA levels. Particularly surprising is that these high oxidative stabilities have been achieved without increasing saturated fat contents to unacceptable levels in an effort to compensate for the increased VLC omega-3 PUFA content. European Patent No. 1 755 409, for example, specifically teaches that liquid oils are undesirable for use with Martek's DHA-containing algal oil, instead saying that one should use such oil with highly-saturated tropical fats, such as palm oil and palm kernel oil.

Oxidative stability can be measured in a variety of ways. As used herein, though, oxidative stability is measured as an Oxidative Stability Index, or OSI, at 80° C. and 110° C., as spelled out below in connection with the Examples. It is worth noting that the temperature at which the OSI test is conducted can significantly impact the measurements, with OSI measurements being significantly lower at higher temperatures. See, for example, García-Moreno, et al., “Measuring the Oxidative Stability of Fish Oil By the Rancimat Test” from the proceedings of Food Innova 2010, Oct. 25-29, 2010, Valencia, Spain, which suggests that a 30° C. increase from 60° C. to 90° C., with all other factors remaining the same, can drive the OSI measurement for fish oil from 18 hours down to less than 2 hours.

In some embodiments, edible fats of this disclosure may exhibit an OSI value at 110° C. of greater than 35 hours, e.g., at least 37 hours, greater than 40 hours, greater than 50 hours, greater than 60 hours, or greater than 69 hours.

### C. Select Embodiments

In one commercially-useful aspect of the present disclosure, the first fat is rapeseed oil and the second fat is marine-, algal-, or vegetable-sourced oil, preferably fish oil or a rapeseed oil containing VLC Omega-3 PUFAs. More specifically, the rapeseed oil may comprise refined, bleached, and deodorized canola oil derived from Brassica napus seeds and may contain at least 65 wt % oleic acid, no more than 4 wt % ALA, and no more than 20 wt % linoleic acid. The marine-, algal-, or vegetable-sourced oil is desirably food grade, such as that available from Jedwards International (noted above), and contains at least 2.5 wt %, e.g., 10 wt % or 15-35 wt %, VLC omega-3 PUFA.

The edible fat desirably includes between 50 wt % and 97 wt %, e.g., 75-96 wt % or 80-96 wt %, of the rapeseed oil and between 3 wt % and 50 wt %, e.g., 4-25 wt % or 4-20 wt %, fish oil or a rapeseed oil containing VLC Omega-3 PUFAs. With the addition of antioxidants, such blends have yielded OSI values greater than 35 hours, e.g., at least 37 hours, with many such blends exceeding 40 hours and some exceeding 50 hours, 60 hours, or even 69 hours.

### Food Products

Aspects of this disclosure allow formulation of food products with relatively high levels of VLC omega-3 PUFA without unduly sacrificing shelf life. In one implementation, food products of the disclosure contain at least 16 mg of VLC omega-3 PUFA (preferably DHA and/or EPA), desirably at least 320 mg of VLC omega-3 PUFA (preferably DHA and/or EPA), per 50 g of the food product.

Some embodiments provide food products comprising edible fats in accordance with the preceding discussion. The edible fat may be incorporated in the food product in any conventional fashion. For example, the food product may comprise a fried food (e.g., French fries or donuts) fried in the edible fat.

In other instances, the edible fat may be mixed with other ingredients of the food product prior to cooking, e.g., to supply some or all of the fat requirements for a batter or the like for a baked food product. Edible fats in accordance with the disclosure appear to be very useful in food products that are cooked with the edible fat included, e.g., by incorporating the edible fat in an uncooked product then cooking to produce the final food product. In baked goods, for example, uncooked product may be a batter or dough that incorporates the edible fat and the uncooked product may be cooked at a temperature of at least 350° F. (e.g., at least 375° F. or at least 400° F.) for at least 10 minutes (e.g., at least 15 minutes, at least 20 minutes, or at least 30 minutes). Edible fats in accordance with this disclosure are expected to withstand the challenging environment of such cooking to provide cooked food products, including baked food products, with both elevated VLC omega-3 PUFA contents and commercially desirable stability and shelf life.

In still other instances, the edible fat may be an ingredient in a food product or a component thereof that does not need to be cooked. In such applications, the edible fat is not subject to the rigors of high-temperature processing. In one such application, the edible fat may be used as a bakery shortening (e.g., a liquid shortening or as a component in a solid or semi-solid shortening) for use in fillings, icings, or the like. In another such application, the edible fat may be sprayed on the food product as a coating, e.g., as a coating applied to crackers, chips, pretzels, cereal products (e.g., ready-to-eat cereals or cereal bars), nuts, or dried fruits.

Knowing the desired fat content of a given food product, the composition of the edible fat may be adjusted to yield a desired VLC omega-3 PUFA content in the food product. For example, the U.S. Food and Drug Administration allows food manufacturers to identify a food product as a “good” source of omega-3 fatty acids if it contains at least 16 mg of EPA plus DHA (i.e., the combined weights of EPA and DHA) per serving and as an “excellent” source if it contains at least 32 mg of EPA plus DHA per serving. In one embodiment, food products of the invention may meet one or both of these criteria without unduly impacting shelf life.

The US FDA sets a “reference amount” for determining an appropriate serving size for a given food product in the U.S., with the reference amount varying from one type of food product to another. As used herein, the term FDA Reference Serving Size for a given food product is the “reference amount” set forth in 21 CFR §101.12 as of 1 Sep. 2009. For example, the FDA Reference Serving Size for grain-based bars such as granola bars is 40 g, for prepared French fries is 70 g, and for snack crackers is 30 g.

By way of example, a food manufacturer may intend to produce a grain-based bar. If the bar includes 1 g of the present edible fat per 40 g FDA Reference Serving Size, an edible fat having 1.65 wt % EPA plus DHA (e.g., sample A4 in Example 1 below) would contribute 16.5 mg of EPA plus DHA per serving, permitting the “good source” designation on the packaging for the bar. If the bar instead includes 2 g of the same edible fat per serving, the bar could be designated as an “excellent source” of EPA plus DHA. Similarly, a bar could be labeled as a “good source” of EPA plus DHA if it contains 1.5 g of an edible fat of the disclosure having 1.1 wt % EPA plus DHA (e.g., sample A3 in Example 1 below) per serving. With the oxidative stabilities of the present edible fats, such food products should have excellent shelf lives despite their high VLC omega-3 PUFA contents.

### EXEMPLARY EMBODIMENTS

Provided is an edible, non-hydrogenated fat having at least 1 weight percent (“wt %”) omega-3 fatty acids with a carbon chain length of twenty or greater and three or more carbon-carbon double bonds (“VLC Omega-3 PUFAs”), no more than 10 wt % saturated fatty acids, and an Oxidative Stability Index (“OSI”) at 110° C. of at least 10 hours in the absence of added antioxidants. In some embodiments, the OSI at 110° C. is at least 15 hours. In some embodiments, the OSI at 110° C. is at least 20 hours.

Also provided is an edible, non-hydrogenated fat having at least wt % omega-3 fatty acids with a carbon chain length of twenty or greater and three or more carbon-carbon double bonds (“VLC Omega-3 PUFAs”) and an OSI at 110° C. of at least 37 hours, the fat comprising a combination of: a first fat comprising a rapeseed oil having at least about 65 wt % oleic acid; a second fat having at least 10 wt % VLC Omega-3 PUFAs; and an antioxidant. In some embodiments, the OSI is at least 40 hours. In some embodiments, the first fat is rapeseed oil having at least 67 wt % oleic acid.

Also provided is an edible fat comprising a combination of a) rapeseed oil having at least about 65 wt % oleic acid, b) fish oil or a rapeseed oil containing VLC Omega-3 PUFAs, and c) an antioxidant, wherein the edible fat has an OSI at 110° C. of at least 37 hours; contains at least 1 weight percent (wt %) omega-3 fatty acids with a carbon chain length of 20 or greater and 3 or more carbon-carbon double bonds (“VLC Omega-3 PUFAs”); and contains no more than 10 wt % saturated fatty acids.

Also provided is a food product comprising the oil of any preceding embodiment. In some embodiments, the food product contains at least 16 mg of EPA plus DHA per FDA reference serving size of the food product. In some embodiments, the food product contains at least 32 mg of EPA plus DHA per FDA reference serving size of the food product.

Also provided is an edible baked food product formed by baking a composition at a temperature of at least 350° F. for at least 15 minutes, the composition including an edible, non-hydrogenated fat comprising a) rapeseed oil having at least 65 weight percent (wt %) oleic acid, b) a marine-, algal-, or vegetable-sourced oil containing omega-3 fatty acids with a carbon chain length of twenty or greater and three or more carbon-carbon double bonds (“VLC Omega-3 PUFAs”), and c) an antioxidant, wherein the edible, non-hydrogenated fat has at least 1 wt % VLC Omega-3 PUFAs and an Oxidative Stability Index (“OSI”) at 110° C. of at least 37 hours. In some embodiments, the baked food product contains at least 16 mg of EPA plus DHA per 40 g of the baked food product. In some embodiments, the baked food product contains at least 32 mg of EPA plus DNA per 40 g of the baked food product. In some embodiments, the OSI at 110° C. is at least 28 hours. In some embodiments, the OSI at 110° C. is at least 30 hours.

Also provided method of making an edible baked food product, the method comprising mixing a composition comprising a first food ingredient, which may be flour, and an edible, non-hydrogenated fat comprising a) rapeseed oil having at least 65 weight percent (wt %) oleic acid, b) a marine-, algal-, or vegetable-sourced oil containing omega-3 fatty acids with a carbon chain length of twenty or greater and three or more carbon-carbon double bonds (VLC Omega-3 PUFAs), and c) an antioxidant, wherein the edible, non-hydrogenated fat has at least 1 wt % VLC Omega-3 PUFAs and an Oxidative Stability Index (“OSI”) at 110° C. of at least 37 hours, and baking the composition at a temperature of at least 350° F. for at least 15 minutes.

### Examples

### Experimental Procedures

The following experimental examples utilize several test protocols:

Oxidative Stability Index (“OSI”): The OSI measurements were carried out in accordance with AOCS Cd 12b-92 at 80° C. and 110° C. as indicated with a 743 RANCIMAT analyzer (Metrohm AG, Herisau, Switzerland) generally in accordance with American Oil Chemists' Society test protocol AOCS Cd 12b-92, except that the sample size of the oil is 3.0 g.

Fatty acid profile (wt %) determination: In accordance with American Oil Chemist's Society Official Method AOCS Ce 1c-89, the oil is treated to convert acylglycerols to fatty acid methyl esters (“FAMEs”) and vials of the FAMEs are placed in a gas chromatograph for analysis in accordance with a modified version of American Oil Chemist's Society Official Method AOCS Ce 1-62. This modified chromatography employs an Agilent 6890 gas chromatograph (Agilent Technologies, Santa Clara, Calif.) equipped with a fused silica capillary column (5 m×0.180 mm and 0.20 μm film thickness) packed with a polyethylene glycol based DB-WAX for liquid phase separation (J&W Scientific, Folsom, Calif.). Hydrogen (H₂) is used as the carrier gas at a flow rate of 2.5 mL/min and the column temperature is isothermal at 200° C.

Schaal Oven Test: The fat is placed in amber glass bottles and the bottles are stored, open to ambient air, in an electrically heated convection oven held at 60° C. The oil is periodically assessed, e.g., by measuring peroxide values and/or conducting sensory testing. This method is commonly referred to as the “Schaal Oven” method and is widely used as an accelerated aging test of shelf stability for oil substrates.

Peroxide Value: Conducted in accordance with American Oil Chemist's Society Official Method AOCS Cd 8b-90.

### Example 1

### Canola/Fish Oil Blends OSI Testing at 110° C.

CLEAR VALLEY 65-brand canola oil (“CV65” in Table 1) was combined with varying amounts of MEG3 Sardine Anchovy fish oil from Ocean Nutrition Canada Limited, Dartmouth, Nova Scotia, Canada, as set forth in Table 1. The OSI value at 110° C. for each of these seven samples was measured without any added antioxidants (“Oil only” in Table 1). A portion of each remaining sample was mixed with TBHQ at a concentration of 200 ppm and the OSI of this second set of samples (“with TBHQ” in Table 1) was measured. Another portion of each remaining sample was mixed with an antioxidant blend of rosemary extract and ascorbic acid sold by Kalsec Inc. of Kalamazoo, Mich., USA (added 0.3 wt % of the weight of the oil) and the OSI was measured (“with RA” in Table 1). The results of the OSI tests are set forth in Table 1; it should be noted that the EPA+DHA content set forth in this table is calculated based on the EPA and DHA content of the fish oil as stated by the manufacturer, not as actually measured.

TABLE 1
Canola/Fish Oil Blends OSI Test Results at 110° C.

| | | | EPA + | OSI | | OSI |
|---|---|---|---|---|---|---|
| | CV65 | Fish Oil | DHA | (Hours) | OSI (Hours) | (Hours) |
| Sample | (wt %) | (wt %) | (wt %) | Oil only | with TBHQ | with RA |
| CV65 | 100 | 0 | 0 | 13.29 | 39.58 | 51.46 |
| A1 | 97.8 | 2.2 | 0.55 | 12.39 | 33.80 | 45.74 |
| A2 | 96.2 | 3.8 | 0.95 | 11.6 | 33.39 | 45.98 |
| A3 | 95.6 | 4.4 | 1.10 | 11.44 | 32.71 | 44.29 |
| A4 | 93.4 | 6.6 | 1.65 | 10.89 | 30.88 | 37.52 |
| A5 | 91.2 | 8.8 | 2.2 | 10.36 | 29.17 | 41.03 |
| A6 | 86.8 | 13.2 | 3.3 | 9.45 | 24.48 | 33.91 |
| Fish Oil | 0 | 100 | 25 | 3.62 | 5.88 | 6.55 |

These results demonstrate that edible fats in accordance with the disclosure can have more than 1 wt % VLC omega-3 PUFA (in this instance, 2 wt % wt % EPA and DHA), yet have an OSI value over 10 hours in the absence of added antioxidants. Sample A5, for example, had 2.2 wt % EPA+DHA and an OSI of over 10 hours.

The measurements with added antioxidants are even more surprising. Examples A3-A5, which have over 1 wt % VLC omega-3 PUFA, had over 25 OSI hours with TBHQ and over 37 OSI hours with the rosemary-based antioxidant, with samples A3 and A5 having over 40 OSI hours.

### Example 2

### Canola/Fish Oil Blends OSI Testing at 110° C.

Much the same process as Example 1 was used to determine the performance of edible fats in accordance with the disclosure containing the same fish oil used in Example 1 and a specialty canola oil having more than 65 wt % oleic acid and less than 5% saturated fat (“LSC” in Table 2). The results are set forth in Table 2; it should be noted that the EPA+DHA content set forth in this table is calculated based on the EPA and DHA content of the fish oil as stated by the manufacturer, not as actually measured.

TABLE 2
Canola/Fish Oil Blends OSI Test Results at 110° C.

| | | | EPA + | OSI | | OSI |
|---|---|---|---|---|---|---|
| | LSC | Fish Oil | DHA | (Hours) | OSI (Hours) | (Hours) |
| Sample | (wt %) | (wt %) | (wt %) | Oil only | With TBHQ | With RA |
| LSC | 100 | 0 | 0 | 26.62 | 38.21 | 95.32 |
| B1 | 97.8 | 2.2 | 0.55 | 22.84 | 36.47 | 62.85 |
| B2 | 96.2 | 3.8 | 0.95 | 20.95 | 35.80 | 62.81 |
| B3 | 95.6 | 4.4 | 1.10 | 20.17 | — | 57.58 |
| B4 | 93.4 | 6.6 | 1.65 | 18.04 | — | 46.02 |
| B5 | 91.2 | 8.8 | 2.2 | 15.98 | — | 58.88 |
| B6 | 86.8 | 13.2 | 3.3 | 13.76 | — | 44.55 |
| B7 | 74 | 26 | 6.5 | 9.69 | 21.54 | 26.46 |
| B8 | 50 | 50 | 12.5 | 6.52 | 12.43 | 15.93 |

This testing demonstrates truly impressive oxidative stability. All of samples B3-B6 have over 1 wt % VLC omega-3 PUFA and OSI values without any added antioxidant of 13.76 hours or higher, with sample B3 having over 20 OSI hours in the absence of added antioxidant. The same samples achieved at least 44 OSI hours with the addition of the rosemary-based antioxidant, with samples B3 and B5 exceeding 55 OSI hours. Such values are well in excess of the minimum values expected for fats used in making shelf-stable food products. Even sample B7, which is over one quarter fish oil and has over 6 wt % VLC omega-3 PUFA, had an OSI over 25 hours.

### Example 3

### Canola/Fish Oil Blends OSI Testing at 110° C.

Much the same process as Example 1 was used to determine the performance of another high-oleic canola oil, CLEAR VALLEY 80-brand canola oil (“CV80” in Table 3A) with the same fish oil used in Examples 1 and 2 in edible fats in accordance with other aspects of the disclosure. In this test, fewer blends were made and all tested samples had 0.3 wt % of the rosemary-based antioxidant added to the oil. The results are set forth in Table 3A.

TABLE 3A
Canola/Fish Oil Blends OSI Test Results at 110° C.

| | CV80 | Fish Oil | EPA + DHA | OSI (Hours) |
|---|---|---|---|---|
| Sample | (wt %) | (wt %) | (wt %) | With RA |
| CV80 | 100 | 0 | 0 | 95.32 |
| C1 | 96 | 4 | 1.2 | 69 |
| C2 | 92 | 8 | 2.4 | 59 |

These results provide oils with over 1 wt % VLC omega-3 PUFA and with OSI values in excess of 60 hours. Given the lengths to which manufacturers go to protect fish oil from oxidation, including multi-layer microencapsulation in some instances, achieving such stability with such an inexpensive approach is truly surprising.

The fatty acid profile of the fish oil used in this Example and the oils C1 and C2 were measured using the modified AOCS Ce 1c-89 protocol noted above. Table 3B sets forth the measured wt % for each of the identified fatty acids, in which the designation “t” indicates a trans-fatty acid.

TABLE 3B
Fatty Acid Profile of Oils

| Fatty Acid | Fish oil | C2 | C1 |
|---|---|---|---|
| 12:0 | 0.1 | 0 | 0 |
| 14:00 | 7.6 | 0.6 | 0.4 |
| 14:1t | 0.3 | 0 | 0 |
| 14:01 | 0.5 | 0.1 | 0.1 |
| 16:00 | 17.5 | 4.4 | 4 |
| 16:1t | 1.2 | 0 | 0 |
| 16:01 | 8.9 | 1 | 0.7 |
| 16:2t | 0.2 | 0 | 0 |
| 16:2t | 0.3 | 0 | 0 |
| 16:02 | 0.3 | 0.2 | 0.3 |
| 18:00 | 4.8 | 2.3 | 2.3 |
| 18:1t | 0.2 | 0.2 | 0.2 |
| 18:1n-9 | 10.8 | 68.8 | 73 |
| 18:1n-6 | 3.2 | 3 | 3.1 |
| 18:2t | 0.5 | 0.1 | 0.3 |
| 18:02 | 3.8 | 8.2 | 8.6 |
| 18:3t | 1.1 | 0.4 | 0.3 |
| 20:00 | 0.3 | 0.8 | 0.8 |
| 20:01 | 1.2 | 1.4 | 1.5 |
| 18:03 | 0.8 | 2 | 2.1 |
| 18:4t | 0.4 | 0.2 | 0 |
| 18:4n-3 | 1.8 | 0.4 | 0.2 |
| 20:02 | 0.5 | 0.2 | 0 |
| 22:00 | 0.1 | 0.5 | 0.5 |
| 22:1n-11 | 0.2 | 0 | 0 |
| 22:1n-9 | 0.2 | 0 | 0 |
| 20:04 | 0.9 | 0.3 | 0 |
| 20:05 | 18.7 | 1.9 | 0.8 |
| 24:00:00 | 0.5 | 0.5 | 0.3 |
| 22:02 | 0.3 | 0.2 | 0 |
| 22:03 | 0.4 | 0.2 | 0 |
| 24:01:00 | 0.9 | 0.6 | 0 |
| 22:04 | 1.1 | 0.3 | 0 |
| 22:5n-6 | 0.6 | 0 | 0 |
| 22:5n-3 | 2.3 | 0.4 | 0 |
| 22:06 | 7.3 | 0.8 | 0.5 |
| Trans fat | 4.2 | 0.9 | 0.8 |
| VLC | 32.2 | 4.5 | 1.3 |
| omega-3 | | | |
| PUFA | | | |
| EPA + DHA | 26 | 2.7 | 1.3 |

Hence, the edible fats C1 and C2 have over 1 wt % VLC omega-3 PUFA, with C2 having over 2.5 wt % EPA plus DHA and 4.5 wt % in total VLC omega-3 PUFA. These measured EPA plus DHA contents are slightly higher than the calculated values set forth in Table 3A, further emphasizing the superior oxidative stability of fats C1 and C2. The OSI value of over 60 hours for edible fat C2 is even more impressive when one considers that the fat contains 4.5 wt % VLC omega-3 PUFA.

### Example 4

### Accelerated Aging (Schaal Oven)

A quantity of CLEAR VALLEY 65-brand canola oil (CV65 in Tables 4A and 4B) and a quantity of the LSC oil of Example 2 each were mixed with the fish oil of Example 1. Each resultant oil was divided into two quantities and the rosemary-based antioxidant of Example 1 was added to one of the two quantities at a level of 0.3 wt %. In Tables 4A and 4B, oil D1 is CV65+fish oil without the added antioxidant; oil D2 is CV65+fish oil with the added antioxidant; oil D3 is LSC+fish oil without the added antioxidant; and oil D4 is LSC+fish oil with the added antioxidant.

Four 100 g samples were taken of each of the four oils (D1-D4). One sample of each oil was measured for peroxide value and subjected to sensory analysis. Each of the other twelve samples (three for each oil) was placed in a separate 500-g amber glass bottle and stored in a Schaal oven for accelerated aging as noted above. At 6 days, 12 days, and again at 14 days, one amber bottle of each oil composition was removed from the oven; the removed samples were subjected to peroxide and sensory testing and the remaining oil in the bottle was flashed with nitrogen and frozen. The sensory evaluation was done by sensory experts using a 10-point scale where a score of 10 reflects the best sensory characteristics and a score of 1 is the worst. A sample is deemed to pass the sensory test if its sensory score is 7 or higher. Table 4A shows the peroxide measurements for each of the 16 samples and Table 4B shows the sensory scores for each of the 16 samples.

TABLE 4A
Peroxide Values at Stated Time

| Oil | Day 0 | Day 6 | Day 12 | Day 14 |
|---|---|---|---|---|
| D1 | 0.41 | 3.16 | 20.40 | 24.52 |
| D2 | 0.01 | 0.02 | 0.25 | 0.02 |
| D3 | 0.22 | 3.05 | 14.10 | 19.40 |
| D4 | 0.01 | 0.05 | 0.01 | 0.24 |

TABLE 4B
Sensory Scores at Stated Time

| Oil | Day 0 | Day 6 | Day 12 | Day 14 |
|---|---|---|---|---|
| D1 | 10 (pass) | 8 (pass) | 4 (fail) | 4 (fail) |
| D2 | 10 (pass) | 10 (pass) | 10 (pass) | 9 (pass) |
| D3 | 10 (pass) | 9 (pass) | 5 (fail) | 3 (fail) |
| D4 | 10 (pass) | 10 (pass) | 9 (pass) | 9 (pass) |

The two oils with added antioxidants, D2 and D4, outperformed the two oils without antioxidants. Interestingly, though, the oils without added antioxidants, D1 and D3, had excellent sensory scores and peroxide values only a little above 3 after nearly a week in the heated Schaal oven. That is substantially better than the fish oil alone, which failed sensory evaluation after just four days of storage at room temperature.

### Example 5

### Consumer Testing of Crackers

Some food products, e.g., crackers, nuts, and dried fruits, are routinely sprayed with oil for a variety of reasons. Shelf-life stability was tested for crackers coated with an edible fat in accordance with an embodiment of the disclosure.

Four 4 kg sets of crackers were each sprayed with a quantity of an oil, with two sets receiving 400 g of sprayed oil and two sets receiving 200 g of sprayed oil. Crackers designated E1 in Table 5 were sprayed with 400 g of oil C1 from Example 3, which provided 3 g of C1 oil (including 32 mg EPA+DHA) per 30 g test sample. Crackers designated E2 in Table 5 were sprayed with 200 g of oil C2 from Example 3, which provided 1.5 g of C2 oil (including 32 mg EPA+DHA) per 30 g test sample. For purposes of comparison, crackers designated E3 and E4 in Table 5 were sprayed with the CV80 oil from Example 3, which contained antioxidant but not fish oil; E3 crackers received 400 g of oil (3 g oil/30 g serving) and E4 crackers received 200 g of oil (1.5 g oil/30 g serving). This is summarized in Table 5A, with the weight of spraying oil being expressed as a percent of the weight of the crackers onto which they were sprayed.

TABLE 5A
Crackers Sprayed with Various Oils

| | | | | EPA + DHA |
|---|---|---|---|---|
| Crackers | Oil type | Oil wt % | Oil g/serving | (mg/serving) |
| E1 | C1 | 10 | 3 | 32 |
| E2 | C2 | 5 | 1.5 | 32 |
| E3 | CV80 | 10 | 3 | 0 |
| E4 | CV80 | 5 | 1.5 | 0 |

### Consumer Difference Testing

A first testing panel of untrained consumers evaluated samples of crackers E1-E4. In particular, each panelist was served 4 crackers of each batch E1-E4 in a 2 oz. plastic cup; samples were served in a balanced triangle rotation and the panelists were not told the differences between the samples. Panelists were instructed to taste the samples in the order in which they were presented and to rinse well with water between samples. The panelists were asked to pick the sample that is different from the rest and comment on any differences that were noted between the samples.

No significant differences (at p<0.05) were noted in the panelists' responses for samples of crackers E1 and E3. These samples had the same amount of fat, but E1 includes 32 mg of EPA+DHA while E3 contains none. There was a significant difference (at p<0.05) in the responses for crackers E2 and E4, which contain the same amount of fat but only E2 has EPA and DHA. The panelists' comments on the differences were inconclusive as to what the difference was, however, and none of the comments from those who correctly identified the E2 sample as different noted any fishy flavor.

Hence, edible fats in accordance with this disclosure can provide food products that are an “excellent” source of EPA and DHA by FDA standards (32 mg/30 g serving of crackers) and are entirely acceptable to consumers.

### Consumer Sensory Testing

A second testing panel of eighty untrained consumers evaluated samples of crackers E1-E4. In particular, each panelist was served four crackers of each batch E1-E4 in a 2 oz. plastic cup; samples were served in a balanced sample rotation and the panelists were not told the differences between the samples. Panelists were instructed to taste the samples in the order on the tray, to rinse well with water between samples, and to taste enough of the sample to form an opinion before evaluating each sample. They were then asked to evaluate the sample by rating overall liking of the sample on a scale of 1-10, with 10 being the highest (Like Extremely) and 1 being the lowest (Dislike Extremely), and recording any notable likes or dislikes for the sample.

No significant differences (p<0.05) were noted between the samples. This reinforces the conclusion that edible fats in accordance with aspects of the invention can provide food products that are well-liked (and largely undistinguishable) by consumers even with the addition of an “excellent” source of EPA and DHA.

### Example 6

### Canola/Fish Oil Blends OSI Testing at 80° C.

CLEAR VALLEY 65-brand canola oil (“CV65” in Table 6) was combined with varying amounts of fish oil from Ocean Nutrition Canada Limited, as set forth in Table 6. The OSI value at 80° C. for each of the samples was measured without any added antioxidants. The results of the OSI tests are set forth in Table 6.

TABLE 6
Canola/Fish Oil Blends OSI Test Results at 80° C.

| | | | OSI |
|---|---|---|---|
| Sample | CV65 (%) | Fish Oil (%) | (Hours) |
| 1 | 86.8 | 13.2 | 69.06 |
| 2 | 91.2 | 8.8 | 72.87 |
| 3 | 93.4 | 6.6 | 77.11 |
| 4 | 95.6 | 4.4 | 77.13 |
| 5 | 96.2 | 3.8 | 87.23 |
| 6 | 97.8 | 2.2 | 88.87 |
| 7 | 100 | 0 | >100 |
| 8 | 0 | 100 | 29.17 |

These results demonstrate that the OSI values for fish oil, canola oil, and canola/fish oil blends are significantly higher at 80° C. than at 110° C. (see Table 1). These results also support the notion that when reviewing published reports of OSI values, attention must be paid to the temperature at which the values were determined.

### Example 7

### OSI of Oils at 80° C. and 110° C.

CLEAR VALLEY 80-brand canola oil (“CV80” in Table 7A) (Cargill, Incorporated, Wayzata, Minn., USA), DHA Vegetarian Algae (“DHA algae” in Table 7A) (Flora Inc., Lynden, Wash., USA), a canola oil including 10 wt % combined DHA, EPA, and DPA (“DHA/EPA canola 10” in Table 7A), EPA fish oil (“EPA fish oil” in Table 7A) (California Natural, Malibu, Calif., USA), and salmon oil (“Salmon oil” in Table 7) (American Health Inc., Ronkonkoma, N.Y., USA) were subjected to OSI testing at 80° C. and at 110° C. at as set forth above. The OSI value at 80° C. and at 110° C. for each of the samples was measured without any added antioxidants. The results of the OSI tests are set forth in Table 7A.

TABLE 7A
OSI Test Results at 80° C. and at 110° C.

| SAMPLE | Temperature | OSI (Hours) | |
|---|---|---|---|
| CV80 | 80° C. | >100 | |
| CV80 | 80° C. | >100 | |
| CV80 | 110° C. | 20.37 | |
| CV80 | 110° C. | 19.94 | |
| DHA algae | 80° C. | 17.12 | |
| DHA algae | 80° C. | 17.69 | |
| DHA algae | 110° C. | 1.78 | |
| DHA algae | 110° C. | 1.60 | |
| DHA/EPA | 80° C. | 46.54 | |
| canola 10 oil | | | |
| DHA/EPA | 80° C. | 52.47 | |
| canola 10 | | | |
| DHA/EPA | 110° C. | 5.23 | |
| canola 10 | | | |
| DHA/EPA | 110° C. | 5.22 | |
| canola 10 | | | |
| EPA fish oil | 80° C. | 9.23 | |
| EPA fish oil | 80° C. | 10.45 | h |
| EPA fish oil | 110° C. | 0.64 | h |
| EPA fish oil | 110° C. | 0.64 | h |
| Salmon oil | 80° C. | 3.53 | h |
| Salmon oil | 80° C. | 3.57 | h |
| Salmon oil | 110° C. | 0.32 | h |
| Salmon oil | 110° C. | 0.30 | h |

These results show that the OSI values for the fish oils and canola oils tested are about ten times higher at 80° C. than at 110° C. DHA/EPA10 canola oil can be stabilized with specialty canola oil (e.g., CLEAR VALLEY-80) and/or by the addition of antioxidants known to those skilled in the relevant arts.

### Example 8

### OSI of Oils with Antioxidants at 110° C.

Materials: CLEAR VALLEY 80-brand canola oil (“CV80”) (Cargill, Incorporated, Wayzata, Minn., USA), canola oil (“Canola”) (Cargill, Incorporated, Wayzata, Minn., USA), MEG3 Sardine Anchovy fish oil (Ocean Nutrition Canada Limited, Dartmouth, Nova Scotia, Canada), GUARDIAN Rosemary Extract 08 (Danisco, Copenhagen, Denmark), GUARDIAN Rosemary Extract 12 (Danisco, Copenhagen, Denmark), GUARDIAN Rosemary Extract 221 (Danisco, Copenhagen, Denmark), GUARDIAN Green Tea Extract 20M (Danisco, Copenhagen, Denmark), and GUARDIAN Green Tea Extract 20S (Danisco, Copenhagen, Denmark).

A blend of CV80 and fish oil (“CV80/Fish”) is prepared by combining CV80 (900.00 g) and MEG3 Sardine Anchovy fish oil (300.02 g). CV80, Canola, and CV80/Fish are combined with antioxidant to provide oil samples having an antioxidant concentration of 1,000 ppm or 2,000 ppm (Table 8). The “Control” for each oil sample does not include added antioxidant.

OSI testing at 110° C. was performed on each of the samples at as set forth above. The results of the OSI tests are set forth in Table 8.

TABLE 8
OSI of Oils with Antioxidants at 110° C.

| | OSI |
|---|---|
| Sample | (Hours) |
| CV80 (Control) | 22.35 |
| CV80 + GUARDIAN Rosemary Extract 08 | 32.69 |
| (2000 ppm) | |
| CV80 + GUARDIAN Rosemary Extract 12 | 25.53 |
| (2000 ppm) | |
| CV80 + GUARDIAN Rosemary Extract 221 | 32.63 |
| (2000 ppm) | |
| CV80 + GUARDIAN Green Tea Extract 20M | 48.69 |
| (1000 ppm) | |
| CV80 + GUARDIAN Green Tea Extract 20S | 54.36 |
| (1000 ppm) | |
| Canola (Control) | 9.92 |
| Canola + GUARDIAN Rosemary Extract 08 | 14.81 |
| (2000 ppm) | |
| Canola + GUARDIAN Rosemary Extract 12 | 11.59 |
| (2000 ppm) | |
| Canola + GUARDIAN Rosemary Extract 221 | 15.48 |
| (2000 ppm) | |
| Canola + GUARDIAN Green Tea Extract 20M | 21.04 |
| (1000 ppm) | |
| Canola + GUARDIAN Green Tea Extract 20S | 24.41 |
| (1000 ppm) | |
| CV80/Fish (Control) | 8.97 |
| CV80/Fish + GUARDIAN Rosemary Extract 08 | 10.91 |
| (2000 ppm) | |
| CV80/Fish + GUARDIAN Rosemary Extract 12 | 10.83 |
| (2000 ppm) | |
| CV80/Fish + GUARDIAN Rosemary Extract 221 | 10.96 |
| (2000 ppm) | |
| CV80/Fish + GUARDIAN Green Tea Extract 20M | 13.12 |
| (1000 ppm) | |
| CV80/Fish + GUARDIAN Green Tea Extract 20S | 14.08 |
| (1000 ppm) | |

These results show that the OSI values for the oils tested are higher when either a rosemary extract or a green tea extract is added to the oil.

### Example 9

### Fatty Acid Profiles and OSI Values of Oils

Materials:

CLEAR VALLEY 80-brand canola oil (“CV80”) (Cargill, Incorporated, Wayzata, Minn., USA), a canola oil including 10 wt % combined DHA, EPA, and DPA (“DHA/EPA canola 10”), a canola oil including 13 wt % combined DHA, EPA, and DPA (“DHA/EPA canola 13”), EPA fish oil (“EPA fish oil”) (California Natural, Malibu, Calif., USA), salmon oil (“Salmon oil”) (American Health Inc., Ronkonkoma, N.Y., USA), DHA Vegetarian Algae (“DHA algae”) (Flora Inc., Lynden, Wash., USA), CLEAR VALLEY Omega-3 oil (“CVOmega3”) (Cargill, Incorporated, Wayzata, Minn., USA), ECOSMART Omega 3 (“ECOSMART Omega 3”) (Carlson Laboratories, Arlington Heights, Ill., USA), NUTRA VEGE Omega3 (“NUTRAVEGE Omega 3”) (Ascenta Health, Dartmouth, Nova Scotia, Canada), and MEG3 Sardine Anchovy fish oil (Ocean Nutrition Canada Limited, Dartmouth, Nova Scotia, Canada).

The fatty acid profiles of oils used in this Example were measured using the modified AOCS Ce c-89 protocol noted above. Tables 9A and 9B set forth the measured wt % for each of the identified fatty acids.

TABLE 9A
Fatty Acid Profile of Oils

| | | | DHA/EPA | DHA/EPA | |
|---|---|---|---|---|---|
| | DHA/ | DHA/ | Canola10: | Canola 13: | EPA |
| | EPA | EPA | CV80 (50: | CV80 (50: | Fish |
| Fatty Acid | Canola 13 | Canola 10 | 50 Blend) | 50 Blend) | vOil |
| C8:0 | 0.00 | 0.00 | 0.00 | 0.00 | 0.30 |
| C9:0 | 0.00 | 0.00 | 0.00 | 0.00 | 0.00 |
| C10:0 | 0.00 | 0.00 | 0.00 | 0.00 | 0.18 |
| C11:0 | 0.00 | 0.00 | 0.00 | 0.00 | 0.00 |
| C12:0 | 0.00 | 0.00 | 0.00 | 0.00 | 0.10 |
| C11:1 | 0.00 | 0.00 | 0.00 | 0.00 | 0.00 |
| C13:0 | 0.00 | 0.00 | 0.00 | 0.00 | 0.03 |
| C12:1 | 0.00 | 0.00 | 0.00 | 0.00 | 0.05 |
| C14:0 | 0.06 | 0.06 | 0.05 | 0.05 | 6.91 |
| C13:1 | 0.00 | 0.00 | 0.00 | 0.00 | 0.00 |
| C14:1 + | 0.00 | 0.04 | 0.03 | 0.02 | 0.51 |
| 15:0 | | | | | |
| C16:0 | 4.61 | 4.81 | 4.06 | 3.96 | 14.70 |
| C16:1 | 0.11 | 0.21 | 0.21 | 0.16 | 8.67 |
| C17:0 | 0.00 | 0.00 | 0.03 | 0.05 | 0.32 |
| C18:0 | 3.14 | 1.96 | 2.00 | 2.60 | 2.71 |
| C18:1 | 23.28 | 28.36 | 52.73 | 50.50 | 9.12 |
| Oleate | | | | | |
| C18:1 | 2.10 | 3.34 | 0.09 | 0.10 | 3.02 |
| Vaccenate | | | | | |
| C18:2 | 31.15 | 30.64 | 19.63 | 19.94 | 4.78 |
| C20:0 | 0.82 | 0.58 | 0.65 | 0.78 | 0.12 |
| C18:3 | 1.57 | 1.05 | 0.53 | 0.74 | 0.27 |
| Gamma | | | | | |
| C20:1 | 0.81 | 0.83 | 1.14 | 1.14 | 0.96 |
| C18:3 | 4.38 | 7.42 | 4.84 | 3.33 | 0.80 |
| Alpha Lin | | | | | |
| C20:2 | 0.86 | 0.74 | 0.39 | 0.45 | 0.47 |
| C22:0 | 0.36 | 0.30 | 0.35 | 0.38 | 0.00 |
| C20:3 | 3.01 | 1.36 | 0.68 | 1.49 | 0.00 |
| Homo Lin | | | | | |
| C22:1 | 0.00 | 0.00 | 0.00 | 0.00 | 0.92 |
| C18:3 | 0.32 | 0.26 | 0.10 | 0.15 | 0.00 |
| 11-14-17 | | | | | |
| C20:4 | 5.17 | 4.19 | 2.13 | 2.49 | 1.24 |
| C23:0 | 0.00 | 0.00 | 0.00 | 0.00 | 0.00 |
| C22:2 | 0.00 | 0.10 | 0.00 | 0.00 | 0.00 |
| C20:5 | 8.42 | 5.88 | 3.03 | 4.06 | 23.00 |
| (EPA) | | | | | |
| C24:0 | 0.00 | 0.12 | 0.20 | 0.15 | 0.00 |
| C22:3 | 0.00 | 0.00 | 0.00 | 0.18 | 0.00 |
| C24:1 | 0.00 | 0.11 | 0.00 | 0.00 | 0.00 |
| C22:4 | 0.97 | 0.78 | 0.35 | 0.50 | 0.91 |
| C22:5N3 | 3.06 | 3.26 | 1.59 | 1.57 | 2.41 |
| (DPA) | | | | | |
| C22:6 | 1.72 | 1.25 | 0.74 | 0.83 | 8.64 |
| (DHA) | | | | | |
| EPA + | 13.20 | 10.39 | 5.36 | 6.45 | 34.04 |
| DPA + DHA | | | | | |

TABLE 9B
Fatty Acid Profile of Oils

| | | DHA | | | |
|---|---|---|---|---|---|
| | | Veg- | | | NUTRA |
| | Salmon | etarian | | ECOSMART | VEGE |
| Fatty Acid | Oil | Algae | CVOmega3 | Omega 3 | Omega3 |
| C8:0 | 0.00 | 15.62 | 0.10 | 0.00 | 22.08 |
| C9:0 | 0.00 | 0.00 | 0.00 | 0.00 | 0.00 |
| C10:0 | 0.00 | 8.17 | 0.05 | 0.00 | 9.86 |
| C11:0 | 0.00 | 0.02 | 0.00 | 0.00 | 0.03 |
| C12:0 | 0.07 | 0.29 | 0.00 | 0.03 | 0.19 |
| C11:1 | 0.00 | 0.00 | 0.00 | 0.00 | 0.00 |
| C13:0 | 0.02 | 0.03 | 0.00 | 0.00 | 0.00 |
| C12:1 | 0.03 | 0.00 | 0.00 | 0.00 | 0.00 |
| C14:0 | 5.22 | 5.07 | 0.07 | 2.54 | 1.26 |
| C13:1 | 0.00 | 0.00 | 0.00 | 0.00 | 0.00 |
| C14:1 + | 0.42 | 0.20 | 0.00 | 0.48 | 0.04 |
| 15:0 | | | | | |
| C16:0 | 14.03 | 0.12 | 4.27 | 14.26 | 6.51 |
| C16:1 | 7.31 | 0.23 | 0.12 | 2.71 | 0.11 |
| C17:0 | 0.25 | 0.00 | 0.05 | 0.99 | 0.06 |
| C18:0 | 3.05 | 0.74 | 2.92 | 2.87 | 2.14 |
| C18:1 | 18.32 | 11.90 | 44.55 | 10.33 | 10.28 |
| Oleate | | | | | |
| C18:1 | 3.09 | 0.11 | 1.52 | 0.34 | 0.33 |
| Vaccenate | | | | | |
| C18:2 | 6.19 | 1.25 | 13.55 | 0.83 | 9.78 |
| C20:0 | 0.17 | 0.00 | 0.33 | 0.35 | 0.00 |
| C18:3 | 0.13 | 0.17 | 0.17 | 4.01 | 0.16 |
| Gamma | | | | | |
| C20:1 | 3.92 | 0.00 | 0.68 | 3.99 | 0.50 |
| C18:3 | 1.75 | 0.00 | 31.33 | 1.03 | 15.63 |
| Alpha Lin | | | | | |
| C20:2 | 0.92 | 0.00 | 0.00 | 0.57 | 0.00 |
| C22:0 | 0.00 | 0.15 | 0.22 | 0.00 | 0.00 |
| C20:3 | 0.00 | 0.23 | 0.00 | 0.00 | 0.00 |
| Homo Lin | | | | | |
| C22:1 | 0.34 | 0.29 | 0.00 | 0.40 | 0.00 |
| C18:3 | 0.00 | 0.00 | 0.00 | 1.36 | 0.00 |
| 11-14-17 | | | | | |
| C20:4 | 0.6.1 | 0.30 | 0.00 | 0.00 | 0.00 |
| C23:0 | 0.00 | 0.31 | 0.00 | 0.00 | 0.00 |
| C22:2 | 0.00 | 0.00 | 0.00 | 0.00 | 0.00 |
| C20:5 | 9.85 | 0.59 | 0.00 | 10.43 | 0.00 |
| (EPA) | | | | | |
| C24:0 | 0.00 | 0.17 | 0.00 | 0.00 | 0.00 |
| C22:3 | 0.00 | 0.00 | 0.00 | 0.83 | 0.00 |
| C24:1 | 0.00 | 0.00 | 0.00 | 0.00 | 0.00 |
| C22:4 | 0.00 | 0.00 | 0.00 | 0.33 | 0.00 |
| C22:5N3 | 3.31 | 0.00 | 0.00 | 1.17 | 0.00 |
| (DPA) | | | | | |
| C22:6 | 9.97 | 29.49 | 0.00 | 24.52 | 5.35 |
| (DHA) | | | | | |
| EPA + | 23.12 | 30.08 | 0.00 | 36.12 | 5.35 |
| DPA + | | | | | |
| DHA | | | | | |

The oils were subjected to OSI testing at 80° C. and at 110° C. at as set forth above. The OSI values at 80° C. and at 110° C. were measured with and/or without added tertiary-butylhydroquinone (“TBHQ”; 0.02 wt %) as indicated in Tables 9C and 9D. The results of the OSI tests are set forth in Tables 9C and 9D.

TABLE 9C
OSI at 80° C. with and without Antioxidant

| | OSI without | OSI with |
|---|---|---|
| Oil Sample | TBHQ (Hours) | TBHQ (Hours) |
| DHA/EPA canola 10 | 49.51 | 73.84 |
| DHA Vegetarian Algae | 17.41 | 21.91 |
| ECOSMART Omega 3 | 11.51 | — |
| EPA Fish oil | 9.84 | 12.51 |
| NUTRA VEGE Omega3 | 40.80 | — |
| Salmon Oil | 3.55 | 8.99 |

TABLE 9D
OSI at 110° C. with and without Antioxidant

| | OSI without | OSI with |
|---|---|---|
| Oil Sample | TBHQ (Hours) | TBHQ (Hours) |
| CV80 | 20.16 | 52 |
| DHA/EPA Canola 13 | 7.94 | — |
| DHA/EPA Canola 10 | 5.23 | 8.21 |
| DHA Vegetarian Algae | 1.69 | 2.14 |
| ECOSMART Omega 3 | 1.15 | — |
| EPA Fish Oil | 0.64 | 1.10 |
| NUTRA VEGE Omega3 | 4.74 | — |
| Salmon Oil | 0.31 | 0.98 |
| DHA/EPA Canola 13:CV80 | 10.53 | 14.91 |
| 50:50 blend | | |
| DHA/EPA Canola 10:CV80 | 11.97 | 17.31 |
| 50:50 blend | | |
| OCEAN NUTRITION MEG3 | 3.65 | 5.88 |
| Sardine Anchovy | | |

These results show that the OSI values at both 80° C. and 110° C. for the oils tested are higher when TBHQ is added to the oil:

### Example 10

### Breads Prepared with Canola Oils

Three bread doughs were prepared using the ingredients listed in Table 10 and three different oils: Dough 1—canola oil (Cargill, Incorporated, Wayzata, Minn., USA); Dough 2—a canola oil including 10 wt % combined DHA, EPA, and DPA (“DHA/EPA canola 10”); and Dough 3—a canola oil including 13 wt % combined DHA, EPA, and DPA (“DHA/EPA canola 13”).

TABLE 10A
Bread Dough Dry Ingredients and Water

| Ingredient | Weight (g) |
|---|---|
| White flour | 1665.3 |
| Sugar | 51.3 |
| Salt | 10.4 |
| Dry yeast | 20 |
| Water | 1009 |

The ingredients listed in Table 10A were combined and mixed in a KITCHENAID Professional 6 mixer (Whirlpool Corporation, Benton Harbor, Mich., USA) at speed 2 for 15 minutes to form a mixture. For Dough 1, to a portion of the mixture was added canola oil (50 g oil/900 g mixture) and the combination was mixed for an additional 10 minutes at speed 2. For Dough 2, to a portion of the mixture was added DHA/EPA canola 10 oil (50 g oil/900 g mixture) and the combination was mixed for an additional 10 minutes at speed 2. For Dough 3, to a portion of the mixture was added DHA/EPA canola 13 oil (50 g oil/900 g mixture) and the combination was mixed for an additional 10 minutes at speed 2. The doughs were covered and allowed to rise for about one hour. The doughs were then punched, shaped, and placed in separate greased baking pans. The doughs were allowed to rise in the baking pans for about 30 minutes and were then placed in an oven heated to 350° F. for about 30 minutes. Each bread type was baked separately for independent aroma evaluation.

The resulting baked breads were removed from the oven and allowed to cool to room temperature and then were weighed. Characteristics of the baked doughs are summarized in Table 10B.

TABLE 10B
Characteristics of Baked Doughs

| | Baked Loaf | Room | Oven | Bread |
|---|---|---|---|---|
| Sample | weight (g) | Aroma | Aroma | Sensory |
| Dough | 818.3 | Strong baked- | Strong baked - | Strong baked - |
| 1 | | bread aroma | bread aroma | bread aroma |
| Dough | 832.4 | Strong baked - | Strong baked - | Strong baked - |
| 2 | | bread aroma | bread aroma | bread aroma |
| Dough | 821.7 | Strong baked- | Strong baked - | Strong baked - |
| 3 | | bread aroma | bread aroma | bread aroma |

As shown in Table 10B, all of the dough samples had a strong baked-bread aroma after baking; no odor of paint, fish, or oxidized oil smell was detected in the baking room, in the baking oven, or emanating from the breads.

The fatty acid profiles of the baked doughs prepared in this Example were measured as follows: Oil was extracted from portions of the baked loaves (10 g) with isooctane (100 mL). The isooctane was subjected to centrifugation to separate the liquid and solid phases, and in accordance with a modified version of American Oil Chemist's Society Official Method AOCS Ce 2-66, aliquots of isooctane including extracted oils (10 mL) are treated to convert acylglycerols to fatty acid methyl esters (“FAMEs”) and vials of the FAMEs are placed in a gas chromatograph for analysis in accordance with American Oil Chemist's Society Official Method AOCS Ce 1 h-05. This chromatography employs an Agilent 7890A gas chromatograph (Agilent Technologies, Santa Clara, Calif.) equipped with a fused silica capillary column (100 m×0.25 mm and 0.20 μm film thickness) packed with non-bonded, polybiscyanopropyl siloxane (Supelco Analytical, Bellefonte, Pa.). Hydrogen (H₂) is used as the carrier gas at a flow rate of 1.0 mL/min and the column temperature is isothermal at 180° C.

TABLE 10C
Fatty Acid Profile of Oils Extracted from Baked Doughs

| | Dough 1 | Dough 2 | Dough 3 |
|---|---|---|---|
| Fatty Acid | Bread | Bread | Bread |
| C8:0 | 0 | 0 | 0 |
| C9:0 | 0 | 0 | 0 |
| C10:00 | 0 | 0 | 0 |
| C11:0 | 0 | 0 | 0 |
| C12:0 | 0 | 0 | 0 |
| C11:1 | 0 | 0 | 0 |
| C13:0 | 0 | 0 | 0 |
| C12:1 | 0 | 0 | 0 |
| C14:0 | 0 | 0 | 0 |
| C13:1 | 0 | 0 | 0 |
| C14:1 + 15:0 | 0 | 0 | 0 |
| C16:0 | 4.484271 | 5.646789 | 5.662874 |
| C16:1 | 0.222448 | 0 | 0.215105 |
| C17:0 | 0 | 0 | 0 |
| C18:0 | 1.876668 | 3.16139 | 2.009315 |
| C18:1 Oleate | 60.518212 | 23.875899 | 29.623825 |
| C18:1 Vaccenate | 3.261889 | 2.094473 | 3.294692 |
| C18:2 | 24.412832 | 32.510157 | 32.688521 |
| C20:0 | 0.630761 | 0.82313 | 0.578346 |
| C18:3 Gamma | 0.16415 | 1.424666 | 0.987884 |
| C20:1 | 1.332181 | 0.834509 | 0.864559 |
| C18:3 Alpha Lin | 3.096588 | 4.356737 | 7.39956 |
| C20:2 | 0 | 0.822363 | 0.672539 |
| C22:0 | 0 | 0.380723 | 0.274916 |
| C20:3 Homo Lin | 0 | 2.834499 | 1.235047 |
| C22:1 | 0 | 0.282055 | 0 |
| C18:311:14:17 | 0 | 0 | 0 |
| C20:4 | 0 | 4.60582 | 3.895987 |
| C23:0 | 0 | 0 | 0 |
| C22:2 | 0 | 0.137296 | 0 |
| C20:5 (EPA) | 0 | 7.423174 | 5.244471 |
| C24:0 | 0 | 0.530899 | 0 |
| C22:3 | 0 | 0 | 0 |
| C24:1 | 0 | 0 | 0 |
| C22:4 | 0 | 1.024137 | 0.706426 |
| C22:5N3 (DPA) | 0 | 2.926645 | 3.115924 |
| C22:6 (DHA) | 0 | 1.338008 | 0.67773 |

As shown in Table 10C, the baked breads made with doughs including DHA/EPA canola 10 oil and DHA/EPA canola oil 13 contain DHA, EPA, and DPA, VLC Omega-3 PUFAs. Surprisingly, as shown in Table 10B, the baked breads including DHA/EPA canola 10 oil and DHA/EPA canola oil 13 had the same favorable “strong baked-bread aroma” as the bread prepared with canola oil that did not include VLC Omega-3 PUFAs.

### Example 11

### OSI Values of CV80 and Fish Oil Blends

CLEAR VALLEY 80-brand canola oil (“CV80” in Table 11A) was combined with varying amounts of MEG3 Sardine Anchovy fish oil (“FO”) from Ocean Nutrition Canada Limited, Dartmouth, Nova Scotia, Canada, as set forth in Table 11A. The OSI value at 110° C. for each of these blends was measured without any added antioxidants. The results of the OSI tests are set forth in Table 11B; it should be noted that the EPA+DHA content set forth in this table is calculated based on the EPA and DHA content of the fish oil as stated by the manufacturer, not as actually measured.

TABLE 11A
CV80 and Fish Oil Blends

| | CV80 | Fish Oil | |
|---|---|---|---|
| BLEND | (wt %) | (wt %) | EPA + DHA % |
| FO16 | 44 | 56 | 16.2 |
| FO12 | 58 | 42 | 12.2 |
| FO8 | 72.5 | 27.5 | 8.0 |
| FO6 | 77.5 | 22.5 | 6.5 |
| FO5 | 83 | 17 | 4.9 |
| FO4 | 86 | 14 | 4.1 |
| FO3 | 89 | 11 | 3.2 |
| FO2.5 | 91.5 | 8.5 | 2.5 |
| FO1.6 | 94.5 | 5.5 | 1.6 |

TABLE 11B
OSI Test at 110° C. Results for CV80 and Fish Oil Blends

| | | OSI | Average |
|---|---|---|---|
| Blend | % EPA + DHA | (Hours) | OSI (Hours) |
| FO16 | 16.2 | 5.74 | |
| FO16 | 16.2 | 5.66 | 5.70 |
| FO12 | 12.2 | 6.77 | |
| FO12 | 12.2 | 6.93 | 6.85 |
| FO8 | 8 | 8.45 | |
| FO8 | 8 | 8.58 | 8.52 |
| FO6 | 6.5 | 9.38 | |
| FO6 | 6.5 | 9.63 | 9.51 |
| FO5 | 4.9 | 10.91 | |
| FO5 | 4.9 | 10.92 | 10.92 |
| FO4 | 4.1 | 11.69 | |
| FO4 | 4.1 | 11.36 | 11.53 |
| FO3 | 3.2 | 12.69 | |
| FO3 | 3.2 | 12.32 | 12.51 |
| FO2.5 | 2.5 | 13.71 | |
| FO2.5 | 2.5 | 13.91 | 13.81 |
| FO1.6 | 1.6 | 15.25 | |
| FO1.6 | 1.6 | 15.25 | 15.25 |
| FO | 25 | 3.20 | |
| FO | 25 | 3.23 | 3.22 |

### Example 12

### OSI Values of CV80 and D16EPA Canola Oil Blends

CLEAR VALLEY 80-brand canola oil (“CV80” in Table 11A) was combined with varying amounts of a canola oil including 16% EPA (“D16EPA”), as set forth in Table 12A. The OSI value at 110° C. for each of these blends was measured without any added antioxidants. The results of the OSI tests are set forth in Table 12B.

TABLE 12A
CV80 and D16EPA Canola Oil Blends

| | | D16EPA | D16EPA | CV80 | | |
|---|---|---|---|---|---|---|
| Sample | CV80 % | % | (g) | (g) | Total g | EPA % |
| 1 | 0 | 100 | 100 | 0 | 100 | 16 |
| 2 | 25 | 75 | 37.50 | 12.98 | 50.48 | 12 |
| 3 | 50 | 50 | 25.50 | 24.50 | 50.00 | 8 |
| 4 | 60 | 40 | 20.07 | 30.22 | 50.29 | 6.4 |
| 6 | 70 | 30 | 15.33 | 34.76 | 50.09 | 4.8 |
| 7 | 75 | 25 | 12.57 | 38.53 | 51.10 | 4 |
| 8 | 80 | 20 | 10.09 | 40.96 | 51.05 | 3.2 |
| 9 | 85 | 15 | 7.58 | 42.59 | 50.17 | 2.4 |
| 10 | 90 | 10 | 5.15 | 45.00 | 50.15 | 1.6 |
| CV80 | 100 | 0 | 0 | 100 | 100 | 0 |

TABLE 12B
OSI Test at 110° C. Results for CV80 and D16EPA Blends

| | OSI | Average |
|---|---|---|
| Sample | (Hours) | OSI (Hours) |
| 1 | 1.86 | |
| 1 | 2.61 | 2.24 |
| 2 | | |
| 2 | 4.00 | 4.00 |
| 3 | 5.96 | |
| 3 | 6.14 | 6.05 |
| 4 | 7.34 | |
| 4 | 7.38 | 7.36 |
| 6 | 9.00 | |
| 6 | 9.19 | 9.10 |
| 7 | 10.38 | |
| 7 | 10.48 | 10.43 |
| 8 | 11.73 | |
| 8 | 11.73 | 11.73 |
| 9 | 12.87 | |
| 9 | 13.15 | 13.01 |
| 10 | 14.78 | |
| 10 | 14.84 | 14.81 |
| CV80 | 21.46 | |
| CV80 | 21.69 | 21.58 |

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. When the claims use the word “or” in reference to a list of two or more items, that word covers all of the following interpretations of the word: any of the items in the list, all of the items in the list, and any combination of the items in the list.

The above detailed descriptions of embodiments of the invention are not intended to be exhaustive or to limit the invention to the precise form disclosed above. Although specific embodiments of, and examples for, the invention are described above for illustrative purposes, various equivalent modifications are possible within the scope of the invention, as those skilled in the relevant art will recognize. For example, while steps are presented in a given order, alternative embodiments may perform steps in a different order. The various embodiments described herein can also be combined to provide further embodiments.

In general, the terms used in the claims should not be construed to limit the invention to the specific embodiments disclosed in the specification, unless the above detailed description explicitly defines such terms.

What is claimed is:

1. An edible, non-hydrogenated fat having at least 1 weight percent (“wt %”) omega-3 fatty acids with a carbon chain length of twenty or greater and three or more carbon-carbon double bonds (“VLC Omega-3 PUFAs”), no more than 10 wt % saturated fatty acids, and an Oxidative Stability Index (“OSI”) at 110° C. of at least 10 hours in the absence of added antioxidants.

2. The edible, non-hydrogenated fat of claim 1, wherein the OSI at 110° C. is at least 15 hours.

3. The edible, non-hydrogenated fat of claim 1, wherein the OSI at 110° C. is at least 20 hours.

4. An edible, non-hydrogenated fat having at least 1 weight percent (“wt %”) omega-3 fatty acids with a carbon chain length of twenty or greater and three or more carbon-carbon double bonds (“VLC Omega-3 PUFAs”) and an Oxidative Stability Index (“OSI”) at 110° C. of at least 37 hours, the fat comprising a combination of:
a first fat comprising a rapeseed oil having at least about 65 wt % oleic acid;
a second fat having at least 10 wt % VLC Omega-3 PUFAs; and
an antioxidant.

5. The edible, non-hydrogenated fat of claim 4, wherein the OSI at 110° C. is at least 40 hours.

6. The edible, non-hydrogenated fat of claim 4, wherein the first fat is a rapeseed oil having at least 67 wt % oleic acid.

7. The edible, non-hydrogenated fat of claim 1, wherein the VLC Omega-3 PUFAs are a marine-, algal-, or vegetable-sourced oil.

8. An edible fat comprising a combination of a) a rapeseed oil having at least about 65 wt % oleic acid, b) a fish oil, and c) an antioxidant, wherein the edible fat
has an Oxidative Stability Index (“OSI”) at 110° C. of at least 37 hours;
contains at least 1 weight percent (“wt %”) omega-3 fatty acids with a carbon chain length of twenty or greater and three or more carbon-carbon double bonds (“VLC Omega-3 PUFAs”); and
contains no more than 10 wt % saturated fatty acids.

9. A food product comprising the edible fat of claim 1.

10. The food product of claim 9, wherein the food product contains at least 16 mg of EPA plus DHA per FDA reference serving size of the food product.

11. The food product of claim 9, wherein the food product contains at least 32 mg of EPA plus DHA per FDA reference serving size of the food product.

12. An edible baked food product formed by baking a composition at a temperature of at least 350° F. for at least 15 minutes, the composition including an edible, non-hydrogenated fat comprising a) rapeseed oil having at least 65 weight percent (“wt %”) oleic acid, b) a marine-, algal-, or vegetable-sourced oil containing omega-3 fatty acids with a carbon chain length of twenty or greater and three or more carbon-carbon double bonds (“VLC Omega-3 PUFAs”), and c) an antioxidant, wherein the edible, non-hydrogenated fat has at least 1 wt % VLC Omega-3 PUFAs and an Oxidative Stability Index (“OSI”) at 110° C. of at least 37 hours.

13. The baked food product of claim 12, wherein the baked food product contains at least 16 mg of EPA plus DHA per 40 g of the baked food product.

14. The baked food product of claim 12, wherein the baked food product contains at least 32 mg of EPA plus DHA per 40 g of the baked food product.

15. The baked food product of claim 12, wherein the OSI at 110° C. is at least 28 hours.

16. A method of making an edible baked food product, the method comprising:
mixing a composition comprising a first food ingredient and an edible, non-hydrogenated fat comprising a) rapeseed oil having at least 65 weight percent (wt %) oleic acid, b) a marine-, algal-, or vegetable-sourced oil containing omega-3 fatty acids with a carbon chain length of 20 or greater and 3 or more carbon-carbon double bonds (“VLC Omega-3 PUFAs”), and c) an antioxidant, wherein the edible, non-hydrogenated fat has at least 1 wt % VLC Omega-3 PUFAs and an Oxidative Stability Index (“OSI”) at 110° C. of at least 37 hours; and
baking the composition at a temperature of at least 350° F. for at least 15 minutes.

17. An edible fat comprising a combination of a) a first rapeseed oil having at least about 65 wt % oleic acid, b) a second rapeseed oil comprising at least 2 wt % omega-3 fatty acids with a carbon chain length of twenty or greater and three or more carbon-carbon double bonds (“VLC Omega-3 PUFAs”), and c) an antioxidant, wherein the edible fat
has an Oxidative Stability Index (“OSI”) at 110° C. of at least 37 hours;
contains at least 1 weight percent (“wt %”) VLC Omega-3 PUFAs; and
contains no more than 10 wt % saturated fatty acids.
